(19) United States
(12) Patent Application Publication
(10) Pub. No.: US 2007/0269025 A1
(43) Pub. Date: Nov. 22, 2007

(54) Managing Customer Access to a Communication Recorded by A Provider in Association with a Transaction

(76) Inventor: Johnny M. Shieh, Austin, TX (US)

Correspondence Address: IBM CORP (AP);C/O AMY PATTILLO, P. O. BOX 161327, AUSTIN, TX, 78716, US

(21) Appl. No.: 11/419,227

(22) Filed: May 19, 2006

(51) Int. Cl. H04M 1/64

(52) U.S. Cl. 379/67.1

(57) ABSTRACT

A method, system, and program are provided for managing customer access to a communication recorded by a provider in association with a transaction between the customer and the provider. A communication system for the provider detects a selection to record a communication between a customer and a provider in association with a particular transaction between the customer and the provider. The communication system records the communication and stores the communication in a database in association with the particular transaction. In addition, the communication system facilitates an interface for the customer to access the recorded communication from the database. The recorded communication may include at least one of a voice communication, a still image of the customer, a video clip of the customer, and a text communication.

### BACKGROUND OF THE INVENTION

1. Technical Field

The present invention relates generally to recording communications and in particular, to managing recordings of communications made in association with a transaction. Further, the present invention relates to managing customer access to a communication recorded by a provider in association with a transaction between the customer and the provider.

2. Description of the Related Art

Many businesses will play a message to a customer, during a telephone call, that alerts the customer to the possibility that the call may be recorded by the business for the business to assure quality of service as part of a telephone transaction. The customer does not have any control over whether the recording is made, other than hanging up if the customer does not want to participate in a recorded call. In addition, the customer does not have any access to the recording, if the recording is even actually made, by the business. Thus, this alert message, while described as a way to assure quality service, actually only provides the business with a way to monitor their employees if they choose to do so.

However, there are often times when a customer could benefit from accessing a recording of a communication made in association with a transaction. Therefore, whether a customer agrees to a transaction over a phone call, at an internet store, or at a vendor's register, it is apparent that it would be advantageous to provide a customer service of allowing the customer to select to have the business actually record any communications associated with the transaction, to store the recording, and to provide the customer with access to the recording in association with the transaction, such that the customer, as well as the business, is provided access to communications associated with transactions.

### SUMMARY OF THE INVENTION

Therefore, the present invention provides a method, system, and program for managing recording of a communication between a customer and a provider in association with a transaction and facilitating customer access to the recorded communication.

In one embodiment, a communication system for the provider detects a selection to record a communication between a customer and a provider in association with a particular transaction between the customer and the provider. The communication system records the communication and stores the communication in a database in association with the particular transaction. In addition, the communication system facilitates an interface for the customer to access the recorded communication from the database. The recorded communication includes at least one of a voice communication, a still image of the customer, a video clip of the customer, and a text communication.

In detecting a selection to record a communication during a telephone call, the communication system prompts the customer to select to record the communication between the customer and the provider in association with the transaction. Responsive to a customer select to record, the communication system triggers recording of the communication during the telephone call between the customer and the provider.

In addition, in detecting a selection to record a communication, the communication system may detect a selection to record an image of the customer. The communication system triggers recording of an image of the customer at the point of purchase or during transaction authorization.

In storing the recorded communication in the database, the communication system may convert the recorded communication from a voice communication format to a second recorded communication in a text format. The communication system stores at least one of the recorded communications in the database in association with the transaction.

In facilitating an interface for the customer to access the recorded communication from the database, the communication system may generate an electronic mail addressed to the customer including at least one of a link to the recorded communication and an attached copy of the recorded communication. The communication system sends the electronic mail to the customer to provide the customer an interface for access to the recorded communication from the database.

In addition, in facilitating an interface for the customer to access the recorded communication from the database, the communication system may receive a request from a customer via a web site interface to access a transaction history for the customer. The communication system searches the database for at least one transaction associated with the customer. In addition, the communication system generates a web page for output to the customer displaying the located transactions and associated recorded communications, where the recorded communications are selectable by the customer for output.

Further, in facilitating an interface for the customer to access the recorded communication from the database, the communication system may provide the customer, during a telephone call, with a selectable menu that includes selecting to access the previously stored recorded communication. Responsive to the customer selection to access the recorded communication, the communication system accesses the recorded communication and controls output of the recorded communication to the customer via at least one open communication channel enabled during the telephone call between the customer and the provider.

Moreover, in facilitating an interface for the customer to access the recorded communication from the database, the communication system may facilitate an audio player to play the recorded communication when the recorded communication is an audio or video communication. The audio player includes a selectable option for the customer to bookmark a time signature during play of the recorded communication. Responsive to a selection by the customer to bookmark a time signature during actual play of a recorded communication accessed from the database, the communication system adds the bookmarked time signature to the entry in the database in association with recorded communication.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a network environment through which customers and providers communicate, in which recordings of communications are made and stored in association with transactions, and through which the customer may access the recorded communications associated with transactions from a database

FIG. 2 is a block diagram depicts one embodiment of a computing system in which the present invention may be implemented;

FIG. 3 is a block diagram depicting one example of types of data fields for entries in a transaction database that includes recorded communications associated with transactions;

FIG. 4 is a block diagram depicting one example of types of data fields for entries in a customer profile database;

FIG. 5 is an illustrative flow diagram illustrating one example of a provider recording communications via a telephone call in association with a transaction;

FIG. 6 is an illustrative flow diagram depicting one example of customer access to a recorded communication associated with a transaction from the transaction database via a telephone call;

FIG. 7 is an illustrative flow diagram illustrating one example of customer access to transaction records with associated recorded communications via a web interface;

FIG. 8 is an illustrative representation of a web page depicting one example of an interface accessible to a customer for accessing previously recorded communication stored in association with transactions in a database;

FIG. 9 is a block diagram illustrating one example of a transaction environment in which multiple types of communications are recorded and stored in a transaction database in association with a transaction;

FIG. 10 is a high level logic flowchart depicting a process and program for managing recordings of communications in association with a transaction for a customer; and

FIG. 11 is a high level logic flowchart depicting a process and program for managing customer accesses to previously recorded communications in association with a transaction between the customer and the provider.

### DETAILED DESCRIPTION OF THE PREFERRED EMBODIMENT

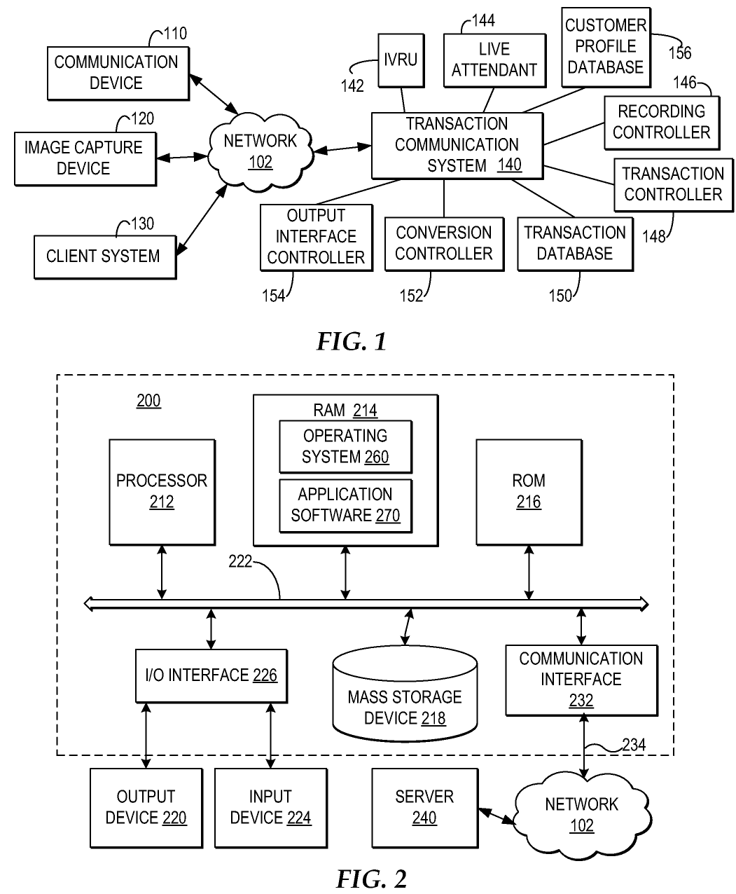

With reference now to FIG. 1, a block diagram depicts a network environment through which customers and providers communicate, in which recordings of communications are made and stored in association with transactions, and through which the customer may access the recorded communications associated with transactions from a database. It will be understood that the network environment may facilitate multiple types of communications via multiple types of networks. In addition, it will be understood that the term “customer” and the term “provider”, as used throughout, may each represent any user and may represent a single or multiple users.

As illustrated, a network 102 facilitates communication between a customer, at one of multiple devices enabled to communicatively connect to network 102, and a provider, through transaction communication system 140. In the example, the devices include, but are not limited to, a communication device 110, image capture device 120, and client system 130. Network 102 may include, but is not limited to, packet-switching networks, such as the Internet or an intranet, and telephony networks, such as the Public Switching Telephone Network (PSTN). In particular, network 102 may include switches and gateways to enable a communication channel of a combination of packet-switching networks and telephony networks.

Transaction communication system 140 may facilitate multiple types of communication mediums for implementing transactions and other communications associated with transactions. In one example, a customer using communication device 110, where communication device 110 is a telephony device, communicates through a telephone call to transaction communication system 140. In another example, a customer communicates an “image” that is captured by image capture device 120, at a point of sale, and transferred in a communication to transaction communication system 140. In yet another example, a customer at client system 130 requests to log in and access transaction information through packet-switched based communications with transaction communication system 140. For example, client system 130 may include a browser or other software that facilitates an interface at client system 130 to interact with transaction communication system 140.

In addition, transaction communication system 140 may be implemented using multiple types of communication systems, separately or in combination, for enabling communication channels for different types of communications, where the communication systems include, but are not limited to, server systems and telephone call exchanges. It is important to note that transaction communication system 140 may also include separate systems and separate types of systems for separate service providers.

Transaction communication system 140 may implement the services of multiple components. In the embodiment, the multiple components include an interactive voice response unit (IVRU) 142, a live attendant 144, a customer profile database 156, a recording controller 146, a transaction controller 148, a transaction database 150, a conversion controller 152, and an output interface controller 154. It will be understood that transaction communication system 140 may include or access additional or alternate components. In addition, it will be understood that the components may by included or accessed in multiple configurations including, but not limited to, implementing components within transaction communication system 140, accessing components from separately functioning systems, or accessing components from a third party service via a network.

In the example, transaction communication system 140 may access an interactive voice response unit (IVRU) 142 that directs customers during a communication, such as a phone call, through an interactive menu of selectable options. In addition, IVRU 142 detects inputs by a customer and converts the inputs into selections from the menu. IVRU 142 may provide the customer with selectable options from the services offered by the provider, including services that facilitate a transaction between the customer and the provider. In addition, in one example, IVRU 142 includes a menu with an option for a user to select to have a call recorded in association with a transaction during the call. In another example, IVRU 142 includes a menu with an option for a user to select to listen to a previously stored recorded communication in association with a transaction between the customer and the provider.

In addition, in the example, transaction communication system 140 may access a live attendant 144. Live attendant 144 represents a person or representative of a provider available to communicate with a customer via voice, text, video, or other communication medium. Transaction communication system 140 may queue communication requests from multiple customers and distribute the requests to one or more live attendants as the representatives become available.

Further, transaction communication system 140 may access transaction controller 148. Transaction controller 148 controls performance of transactions between the customer and a provider. A record of each transaction is placed in transaction database 150. A transaction may include, but is not limited to, a financial transaction, a verbal transaction, a service transaction, or any other type of exchange of goods, services, or money or agreement to a future exchange between a customer and a provider.

A recording controller 146 records communications between a customer and a provider. A communication between a customer and a provider may include two way communication or one way communication. In one example, recording controller 146 records the voice communications during a telephone call between a customer at communication device 110 and live attendant 144. In another example, recording controller 146 records the text communications during a text messaging session between a customer at client system 130 and live attendant 144. In yet another example, recording controller 146 records the images captured by image capture device 120. Further, in yet another example, recording controller 146 records a voice communication in response to a customer selection to record an audio file in association with a transaction. Further, it will be understood that recording controller 146 may record any communication associated with a transaction performed by a transaction controller 148.

Recording controller 146 directs attachment of each recording to an associated transaction in transaction database 150. If a customer communicates with multiple separate live attendants or other entities during the process of completing the transaction, then a record of each communication is attached to the associated transaction in transaction database 150 with an additional entry indicating the forwarding trail.

In addition, recording controller 146 may trigger conversion controller 152 to convert a recorded communication from one format to another format. For example, conversion controller 152 may convert a voice recording to a text recording.

In the example, transaction communication system 140 also accesses output interface controller 154. Output interface controller 154 facilitates output of entries in transaction database 150, including attached recorded communications, to multiple types of output interfaces to provide customers access to records stored for each transaction. In one example, output interface controller 154 facilitates output of entries in an email to the customer's email service provider (not depicted), where the customer is able to select to listen to the recorded communications from the email. In another example, output interface controller 154 is triggered by a customer selection detected by IVRU 142 to play transaction entries, output interface controller 154 triggers conversion controller 152 to convert textual transaction information into voice information, and then output interface controller 154 plays the voice transaction information to a customer at communication device 110 during a call and enables a caller to select to also listen to recorded communications in association with the transactions. Further, in yet another example, output interface controller 154 provides a web site interface through which a customer at client system 130 connects to access information about previous transactions, including recorded communications associated with previous transactions. It will be understood that output interface controller 154 may facilitate additional output interfaces for enabling customer access to transaction entries and recorded communications associated with transaction entries.

In addition to facilitating access to a stored recorded communication, output interface controller 154 may provide realtime streaming of the recording or the converted text of the recording to the customer at a communication device as the communication occurs, where the customer may then store the streamed recording at the communication device, such as communication device 110 or client system 130. In addition, output interface controller 154 may control realtime streaming or other download of the recorded communication as the communication occurs or prior to the end of a communication session with a customer, where output interface controller 154 adds data security to the recorded communication such as encryption, watermarking or other data security measure that enables the provider to later authenticate the recording.

In accessing transactions, including recorded communications associated with transactions, via output interface controller 154, output interface controller 154 may also offer the customer the option to select to download transaction records, download recorded communications, contest a transaction, bookmark a location in a recorded communication, or other interaction which provides the customer with additional services in association with transaction records and associated recorded communications accessed from transaction database 150. For each access to data from transaction database 150, output interface controller 154 may update the accessed transaction records in transaction database 150 to include the access date, time, accessing device, and other information associated with the access. In addition, in the example where a customer selects to contest a transaction, output interface controller 154 updates the contested transaction record in transaction database 150 and may trigger other services provided by the provider when a transaction is contested.

A customer profile database 156, accessible to transaction communication system 140, includes a profile for each customer that may be only accessible to transaction communication system 140 or may be shared across multiple systems via network 102. Profile information included in customer profile database 156 may enable transaction communication system 140 to authenticate a customer, customize services and recording options provided to a customer, and customize access.

Referring now to FIG. 2, a block diagram depicts one embodiment of a computing system in which the present invention may be implemented. The present invention may be executed in a variety of systems, including a variety of computing systems, such as computing system 200, communicatively connected to a network, such as network 102. For example, any of communication device 110, image capture device 120, client system 130, transaction communication system 140 or any of the components described with reference to transaction communication system 140, may be implemented using a computing system or grouping of computing systems, such as computing system 200.

Computer system 200 includes a bus 222 or other communication device for communicating information within computer system 200, and at least one processing device such as processor 212, coupled to bus 222 for processing information. Bus 222 preferably includes low-latency and higher latency paths that are connected by bridges and adapters and controlled within computer system 200 by multiple bus controllers. When implemented as a server, computer system 200 may include multiple processors designed to improve network servicing power. Where multiple processors share bus 222, additional controllers (not depicted) for managing bus access and locks may be implemented.

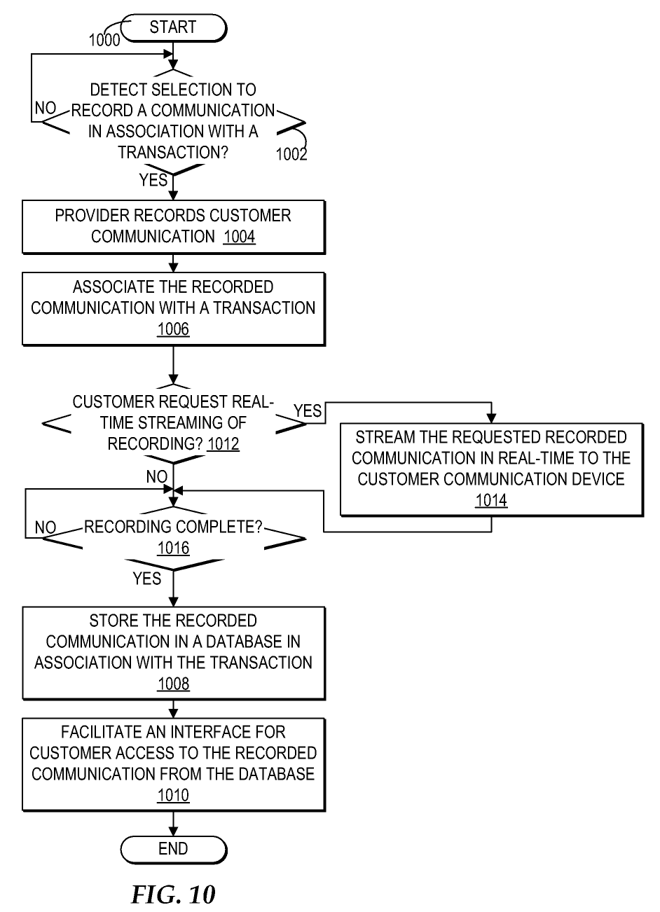

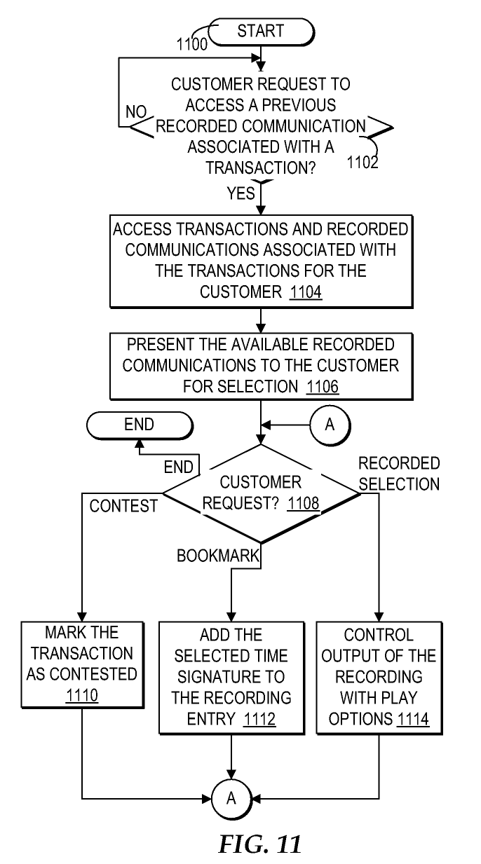

Processor 212 may be a general-purpose processor such as IBM's PowerPC™ processor that, during normal operation, processes data under the control of an operating system 260, application software 270, middleware (not depicted), and other code accessible from a dynamic storage device such as random access memory (RAM) 214, a static storage device such as Read Only Memory (ROM) 216, a data storage device, such as mass storage device 218, or other data storage medium. In one embodiment, the operations performed by processor 212 may control management of recording communications made in association with a transaction and facilitate customer access to the recorded communications as depicted in the operations of flowchart of FIGS. 10 and 11 and other operations described herein. Operations performed by processor 212 may be requested by operating system 260, application software 270, middleware or other code or the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 200 to perform a process according to the present invention. The term “machine-readable medium” as used herein includes any medium that participates in providing instructions to processor 212 or other components of computer system 200 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 200 can read and which is suitable for storing instructions. In the present embodiment, an example of a non-volatile medium is mass storage device 218 which as depicted is an internal component of computer system 200, but will be understood to also be provided by an external device. Volatile media include dynamic memory such as RAM 214. Transmission media include coaxial cables, copper wire or fiber optics, including the wires that comprise bus 222. Transmission media can also take the form of acoustic or light waves, such as those generated during radio frequency or infrared data communications.

Moreover, the present invention may be downloaded or distributed as a computer program product, wherein the program instructions may be transferred from a remote computer such as a server 240 to requesting computer system 200 by way of data signals embodied in a carrier wave or other propagation medium via network 102 to a network link 234 (e.g. a modem or network connection) to a communications interface 232 coupled to bus 222. Communications interface 232 provides a two-way data communications coupling to network link 234 that may be connected, for example, to a local area network (LAN), wide area network (WAN), or directly to an Internet Service Provider (ISP). In particular, network link 234 may provide wired and/or wireless network communications to one or more networks, such as network 102. Further, although not depicted, communication interface 232 may include software, such as device drivers, hardware, such as adapters, and other controllers that enable communication. When implemented as a server, computer system 200 may include multiple communication interfaces accessible via multiple peripheral component interconnect (PCI) bus bridges connected to an input/output controller, for example. In this manner, computer system 200 allows connections to multiple clients via multiple separate ports and each port may also support multiple connections to multiple clients.

Network link 234 and network 202 both use electrical, electromagnetic, or optical signals that carry digital data streams. The signals through the various networks and the signals on network link 234 and through communication interface 232, which carry the digital data to and from computer system 200, may be forms of carrier waves transporting the information.

In addition, computer system 200 may include multiple peripheral components that facilitate input and output. These peripheral components are connected to multiple controllers, adapters, and expansion slots, such as input/output (I/O) interface 226, coupled to one of the multiple levels of bus 222. For example, input device 224 may include, for example, a microphone, a video capture device, a body scanning system, a keyboard, a mouse, or other input peripheral device, communicatively enabled on bus 222 via I/O interface 226 controlling inputs. In addition, for example, a display device 220 communicatively enabled on bus 222 via I/O interface 226 for controlling outputs may include, for example, one or more graphical display devices, audio speakers, and tactile detectable output interfaces, but may also include other output interfaces. In alternate embodiments of the present invention, additional or alternate input and output peripheral components may be added.

Those of ordinary skill in the art will appreciate that the hardware depicted in FIG. 2 may vary. Furthermore, those of ordinary skill in the art will appreciate that the depicted example is not meant to imply architectural limitations with respect to the present invention.

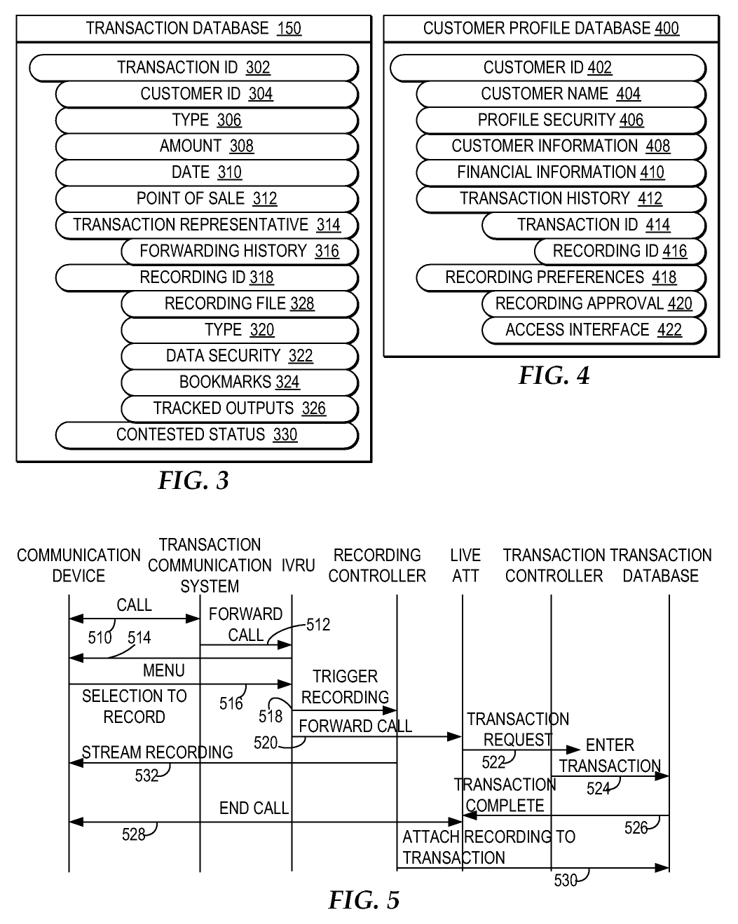

With reference now to FIG. 3, a block diagram depicts one example of types of data fields for entries in a transaction database that includes recorded communications associated with transactions. In the example, transaction database 150 includes examples of multiple types of data fields which may be included in a transaction entry within transaction database 150. It will be understood that transaction database 150 may include multiple transaction entries and that transaction entries may be organized using different filing systems.

In the example, each transaction entry is identified by a unique transaction identifier (ID) 302. Transaction ID 302 may include a name, number, or other identifier to identify the transaction. In addition, each transaction entry includes a customer ID 304, which uniquely identifies the customer involved in the transaction. It will be understood that each transaction entry may include additional types of identifiers for identifying the transaction.

In addition, in the example, each transaction entry may identify information about the transaction. For example, where the transaction is a purchase, the transaction entry may identify a type of purchase 306, an amount of purchase 308, a date of purchase 310 and a point of sale 312. It will be understood that for other types of transactions, other types of information may be stored about the transaction.

Further, each transaction entry may identify a transaction representative 314, which includes an identifier for each representative associated with the transaction. Where the transaction occurs during a phone call and the customer is transferred from representative to representative during the call a forward history 316 includes the forwarding path of the call.

Each transaction entry also includes entries for each recorded communication attached to the transaction entry. In the example, each recorded communication, whether a recording of voice, text, graphic, photo, or video, includes a recording ID 318. Associated with each recording ID 318, the transaction entry includes the storage location of the recorded communication in recording file 328.

In addition, each recorded communication associated with a transaction may include information about the type of recording 320, the data security associated with the recording 322, bookmarks 324, and the tracked outputs of the recording 326. Type of recording 320 may indicate whether the recording is a voice, text, photo, or video recording, for example. Data security 322 may indicate whether the communication is encrypted, watermarked, or digitally protected in some way. Bookmarks 324 include time signatures marked by the customer or the provider within each recording. Tracked outputs 326 may include the date, time, output format, and other information about accesses to the recording by the customer and the provider.

Further, each transaction entry may include a contested status 330 that indicates whether the customer has contested the transaction. Additional fields of information may be added once a customer contests a transaction entry to track the provider's response to the contested entry and any resolution of the contested transaction entry. In one example, by recording voice communications associated with a transaction, such as the conversation between the customer and a live attendant, and providing the customer with access to the conversation, the customer may later listen to the recording, bookmark a particular time signature location within the recording and contest the transaction based on the recording, starting at the particular time signature. In another example, by recording image communications associated with a transaction, such as capturing an image of the customer who approves a transaction at a store-front, the customer may later view the image and contest the transaction based on the captured not image not being the customer or an authorized representative of the customer.

Referring now to FIG. 4, a block diagram depicts one example of types of data fields for entries in a customer profile database. In the example, customer profile database 156 includes examples of multiple types of data fields which may be stored for each customer within customer profile database 156. In the example, each customer profile is identified by a customer ID 402, which may include a unique number, text, or other identifier. In addition, the customer is identified by a customer name 404 and profile security 406, where profile security 406 may include a voice imprint, encryption key, or other data that can be used to authenticate the identity of a customer.

In addition, generally, customer profile database 156 identifies customer information 408 which may include additional fields with information such as, but not limited to, customer preferences, employer, purchase history, and other information. In addition, customer profile database 156 identifies financial information 410 which may include account numbers, account providers, and other information that would enable the provider to complete a financial transaction with a customer.

Customer profile database 156 may include transaction history 412, which includes a transaction ID 414 for each transaction and a recording ID 416 for each recorded communication associated with a transaction. In one example, transaction ID 414 and recording ID 416 link to transaction ID 302 and recording ID 318 of FIG. 3.

In addition, customer profile database 156 includes recording preferences 418. In the example, recording preferences 418 includes entries for recording approval 420 and access interface 422. Recording approval 420 may indicate whether a customer automatically approves a provider to record communications associated with a transaction, whether the customer selectively approves particular types of recordings in association with a transaction, or whether the customer requests to be prompted with the option to record, for example. Access interface 422 may indicate the interfaces selected by the customer for accessing recorded communications. For example, a customer may indicate a preference to automatically receive an email with a link to or attachment of any recorded communications stored in the transaction database in association with a transaction. In another example, a customer may indicate preferences for viewing transactions and accessing recorded communications via a web site interface. In yet another example, a customer may indicate a preference for receiving the recorded communication, as the communication is recorded, in real-time through streaming or download and may also indicate a preference to receiving the converted text from a recorded communication in real-time.

It will be understood that transaction database 150 and customer profile database 156 may be combined into a single database or may be relationally connected. In addition, it will be understood that different levels of security may be applied to different entries within each of transaction database 150 and customer profile database 156 and that these databases may be further linked to other databases and other types of information.

With reference now to FIG. 5, an illustrative flow diagram shows one example of a provider recording communications via a telephone call in association with a transaction. As illustrated at reference numeral 510, at least one communication channel for a call is opened between a communication device and a transaction communication system. The transaction communication system forwards the call to an IVRU, as illustrated at reference numeral 512. In addition, although not depicted, the call may be placed in a call queue or other call hold system. The IVRU plays a menu of options to the communication device, as illustrated at reference numeral 514. Included in the menu, is an option to select to record any communications during the call. As illustrated at reference numeral 516, the customer selects a menu option to select to record any communications during the call. Next, as illustrated at reference numeral 518, the IVRU detects the menu selection and triggers the recording controller to record any communications during the call. In addition, as illustrated at reference numeral 520, the IVRU forwards the call to an attendant. Although not depicted, a customer may select additional menu options that direct the IVRU to forward the call to an attendant.

The live attendant and the customer communicate via the forwarded call channel. The recording controller records the communications. In addition, in the example, the live attendant sends a transaction request to the transaction controller, as illustrated at reference numeral 522. The live attendant may send the request through a terminal communicatively connected to transaction controller, through another telephone channel, or through other forms of communication with the transaction controller. The transaction controller enters the transaction in the transaction database 524. Once the transaction is complete or verified, the transaction controller sends a transaction complete communication to the live attendant, as illustrated at reference numeral 526. In addition, the transaction controller may provide a voice communication to the customer that includes a transaction verification identifier.

Once the call ends, as illustrated at reference numeral 528, the recording controller adds the recorded communication to the associated completed transaction in the transaction database. In one example, the attendant triggers the recording controller to end the recording and updates the recording controller with the transaction ID. In another example, the recording controller receives a call ID for the call from the IVRU, monitors the call, detects when the call ends, and sends the recording to the transaction database with the call ID, which the transaction database associates with the transaction completed during the call. In addition, it will be understood that other services and systems may be implemented to associate a recorded communication with a transaction in the transaction database.

In another example, when the customer listens to the menu of options provided by the IVRU, the menu may include a selection to not only record the communication, but for the customer to receive a real-time streaming of the recorded communication or the converted text of the communication. If the customer selects to receive a real-time streaming of the recorded communication, then once the recording controller triggers recording of the communication, the recording controller may begin to stream the recorded communication to the communication device in real-time, as illustrated at reference numeral 532. The communication device may then save the streamed recording, such that the customer receives and may retain a copy of the recorded communication, as the recording occurs. In an alternate example, another controller, such as the output interface controller, may control the streaming of the communication in real-time. In addition, in another example, the recorded communication is first converted from voice to text and the text is streamed to the communication device. In yet another example, the recording controller or other controller streams or downloads the recording of the communication at the conclusion of the recording. Further, the recording controller or other controller may add digital security to the streamed recording, such that the provider may later verify the authenticity of a recording provided by the customer in contesting a transaction or for other communications.

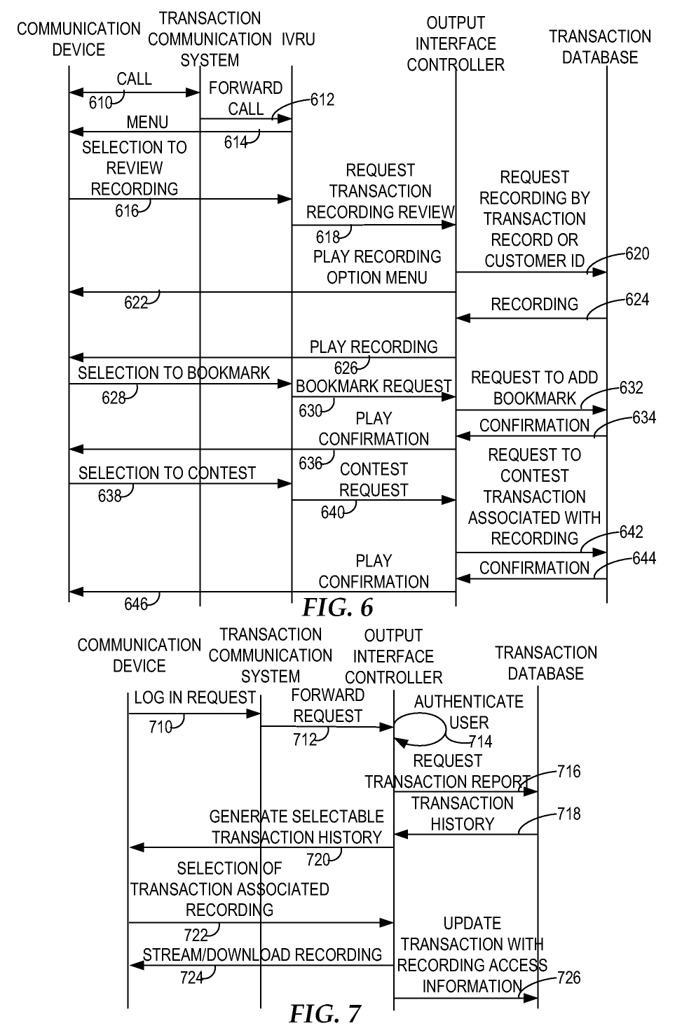

Referring now to FIG. 6, an illustrative flow diagram depicting one example of a customer access to a recorded communication associated with a transaction from the transaction database via a telephone call. As illustrated at reference numeral 610, a communication channel for a call is opened between a communication device and a transaction communication system. The transaction communication system forwards the call to an IVRU, as illustrated at reference numeral 612. The IVRU plays a menu of options to the communication device, as illustrated at reference numeral 614. Included in the menu is an option to select to listen to a recorded communication stored in association with a transaction. In another example, a menu option may include listening to records of transactions, where the customer is provided the option to also select to listen to a recorded communication associated with a particular transaction.

As illustrated at reference numeral 616, the customer selects the option to select to access a recorded communication stored in association with a transaction. Next, as illustrated at reference numeral 618, the IVRU passes the request to the output interface controller. The output interface controller detects a transaction ID or customer ID associated with the request and queries the transaction database to access the requested recorded communication, as illustrated at reference numeral 620. In addition, the output interface controller plays a recording option menu or triggers the IVRU to play the recording option menu, as illustrated at reference numeral 622. Further, the output interface controller receives the recorded communication from the transaction database, as illustrated at reference numeral 624, and plays the recorded communication to the communication device, as illustrated at reference numeral 626.

Before, during, or after the play of the recorded communication, a customer may select from options in the recording option menu. For example, the customer may select to fast forward, stop, pause, play, or rewind the playback of the recorded communication by selecting inputs specified in the recording option menu.

In another example, as illustrated at reference numeral 628, a customer may select to bookmark a particular location in the playback of the recorded communication. The IVRU detects the selection and a time signature of the recorded communication when the selection to bookmark is made and transfers a bookmark request to the output interface controller, as illustrated at reference numeral 630. The output interface controller sends the request to add a bookmark to the recording, as illustrated at reference numeral 632. In adding a bookmark to a recording, an entry indicating the particular time signature within the recording playback is added to the recording record in the transaction database. The transaction database sends a confirmation of the addition, as illustrated at reference numeral 634, and the output interface controller plays a message indicating the marker has been added to the recorded communication record, a illustrated at 636.

In yet another example, as illustrated at reference numeral 638, a customer may select to contest a particular transaction during the playback of the recorded communication associated with that transaction. The IVRU detects the selection and transfers a request to contest the transaction, as illustrated at reference numeral 640. The output interface controller sends the request to mark the transaction associated with the current recording as contested, as illustrated at reference numeral 642. In marking a transaction as contested, the output interface controller may trigger additional steps to trigger review of the contested transaction by the provider. The transaction database sends a confirmation of the contested status, as illustrated at reference numeral 644, and the output interface controller plays a message indicating the current contested status, as illustrated at reference numeral 646. In addition, in marking a transaction as contested, the customer may select to reference a bookmark in the recording to reference a point in the recording to review when the provider reviews the transaction.

With reference now to FIG. 7, an illustrative flow diagram depicting one example of a customer access to transaction records with associated recorded communications via a web interface. As illustrated at reference numeral 710, a communication device sends a log in request to a transaction communication system. In the example, the transaction communication system initially presents the communication device with access to a web site through which the customer may request to log in to access transaction information. It will be understood that other communication interfaces may be implemented for enabling a customer to access information stored in a provider's transaction database.

The transaction communication system forwards the request to the output interface controller, as illustrated at reference numeral 712. Next, the output interface controller authenticates the user requesting to log in, as illustrated at reference numeral 714. Alternatively, the provider communication system may pass the log in request to an authentication service that authenticates the user requesting to log in. The output interface controller requests a transaction report for the customer, as illustrated at reference numeral 716. The transaction database gathers the transaction entries for the customer and returns a transaction history of the transaction entries, including previously recorded communications, as illustrated at reference numeral 718. The output interface controller generates a selectable transaction history for output via the web page at the communication device, including selectable options for listening to associated recorded communications, as illustrated at reference numeral 720.

The customer views the web page with selectable transaction information and selects a recorded communication associated with a transaction, which triggers a request from the communication device to the output interface controller, as illustrated at reference numeral 722. The output interface controller receives a recording play request and streams or downloads the recording to the communication device, as illustrated at reference numeral 724. Alternatively, the output interface controller may automatically download copies of each recorded communication to the communication device with the transaction history. In addition, the output interface controller updates the transaction record to include information about the access to the recorded communications, as illustrated at reference numeral 726. Additionally, although not depicted, as described with reference to FIG. 6, via the web site interface, a customer may select to mark a particular time signature within a recorded communication, which the output interface controller updates in the transaction database, and a customer may select to contest a transaction, which the output interface controller updates in the transaction database. In addition, it will be understood that additional or alternate options for reviewing and interacting with transaction database information may be provided to a customer by the output interface controller via a web site or other network portal.

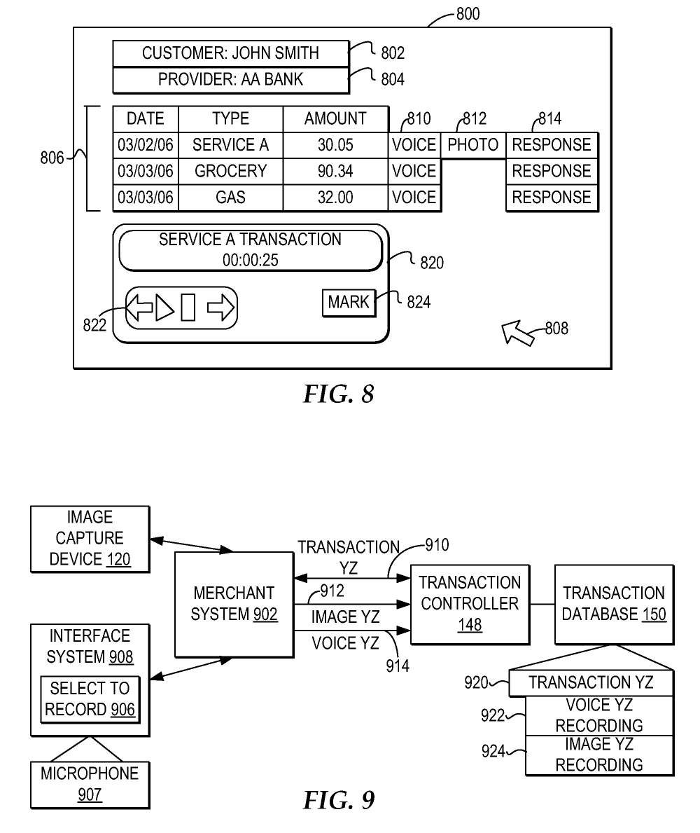

Referring now to FIG. 8, an illustrative representation of a web page shows one example of an interface accessible to a customer for accessing previously recorded communication stored in association with transactions in a database. In the example, a web site interface 800 includes an identifier of the customer, as illustrated at reference numeral 802, and an identifier of the provider, as illustrated at reference numeral 804. The example illustrated shows the interface provided to a customer of a transaction history, once the customer has logged in. In particular, the example illustrates multiple financial transactions between the customer and the provider where the provider is a financial institution, such as a bank or credit card provider, or an online merchant from whom the customer has made previous purchases.

In the example, a table 806 includes selectable listings of transactions, including a date, type of transaction, amount, and recorded communication selections. In the example, the type of transaction indicates the type of merchant from which a purchase was made, where the merchant charged the cost of the purchase to the customer's account with the provider. It will be understood that other types of information may be illustrated to represent a type of transaction.

In addition, in the example, a customer may select to view additional information about a transaction by positioning cursor 808 over a particular transaction entry within table 806 and selecting the transaction. It will be understood that cursor 808 provides one method for customer input and selection, however, web site interface 800 may support other methods of customer input and selection.

Further, in the example, the recorded communication selections for each transaction entry may include a selectable voice recording and a selectable image recording, such as selectable voice recording 810 and selectable image recording 812. In the example, only the first transaction includes both a selectable voice recording and selectable image recording, however, in another example, each merchant may be required to enable the provider to collect both types of recordings. A user may select to listen to a voice recording associated with a transaction or view a recorded image associated with the transaction by positioning cursor 808 over one of the selectable images and selecting the image. It will be understood that additional selectable recording options may be included. For example, a selectable video recording, textual recording, or other types of recording may be provided within web site interface 800.

In the example, web site interface 800 includes an interface for controlling play of voice recordings. In the example, player 820 includes controls 822 for controlling the play position within a recording and interface 826 for displaying the identifier of the currently playing recording and current play location of the recording. For example, interface 826 identifies the recording currently playing as associated with “service A transaction” and the current play location of “00:00:25”. Within player 820, a customer may select to mark a particular time signature, of a current play location, during the play of the recording by selecting recording mark option 824. It will be understood that additional or alternate options may be provided through player 820. In addition, it will be understood that player 820 may also facilitate play of video recordings in association with transactions. Further, it will be understood that for other types of recordings, such as text or image recordings, web site interface 800 may include additional types of interfaces for user viewing of the recording.

In addition, in the example, the selections for each transaction entry may include a selectable response option, such as selectable response 814. For example, a selectable response may include selecting to record an additional communication to associate with the transaction. In another example, a selectable response may include selecting to contest the transaction. It will be understood that additional or alternate options for user response to a transaction and recording may be included.

With reference now to FIG. 9, a block diagram illustrates one example of a transaction environment in which multiple types of communications are recorded and stored in a transaction database in association with a transaction. In the example, a merchant system 902 represents a point of purchase system, which may integrate into or access transaction communication system 140. In one example, where merchant system 902 represents with a store front, including registers or other points of sale, merchant system 902 may incorporate many different systems communicatively connected via a network or hardwire. In another example, where merchant system 902 represents an electronic merchant, with a web site store front, merchant system 902 may incorporate additional systems and services for facilitating electronic commerce. It is important to note that merchant system 902 may implement multiple transactions, such as a first transaction between the customer and the merchant and a second transaction between the merchant and a financial institution providing an account for the customer. In one example, the transaction between the customer and the provider may represent any one of the transaction between the customer and the financial institution via the merchant, the transaction between the customer and the merchant, and the transaction between the merchant and the financial institution.

In the example, merchant system 902 interacts with transaction controller 148 to communicate about and complete a transaction, such as “transaction YZ” illustrated at reference numeral 910. Each transaction is added as a transaction entry, such as transaction entry 920, to a transaction database 150. It will be understood that each transaction entry 920 may include multiple fields of information, such as, but not limited to, the fields of a transaction entry described with reference to FIG. 3.

In addition, in the example, a customer interacts with merchant system 902 through an interface system 908. In one example, interface system 908 is a customer interactive interface at a register or other point of purchase. For example, interface system 908 may represent the self-swipe credit card terminal at which a customer swipes and credit card or other financial card and agrees to a purchase amount. In another example, interface system 908 is a system at which a customer accesses the web site for an electronic merchant.

Interface system 908 incorporates a microphone 907 or other voice recording device. In addition, interface system 908 includes a selectable recording option 906 for a customer to select to record a communication associated with the transaction. For example, at the credit card terminal, the customer presses a button, representing selectable recording option 906, to select an option to activate microphone 907 in interface system 908, the customer speaks a message to be recorded by merchant system 902, merchant system 902 transfers the voice message to transaction controller 148 as a voice recording, such a “voice YZ” illustrated at reference numeral 912, and transaction controller 148 stores the voice recording in transaction database 150 in association with the transaction performed via merchant system 902 as illustrated at reference numeral 922. In another example, an electronic merchants' web site interface may include selectable recording option 906 as a selectable button, where selection of the option 906 triggers activation of the microphone at interface system 908 to facilitate a customer recording a message for storage with the transaction as described in the previous example. By enabling a customer to select to record a voice communication with a transaction, the customer may select to record information about the transaction that would be helpful to the customer when the customer reviews the transaction record at a later time. For example, when a customer is filling up with gas, the customer may select to record a voice message to attach to the transaction that indicates whether the customer is filling up a personal car or a business car, so the customer can later look at the transaction, listen to the recording, and correctly itemize the transaction.

In addition, interface system 908 may link to image capture device 120. For example, image capture device 120 may represent a still image or video image capture device. With each transaction, a customer may select to trigger the capture of an image of the customer, at the point of purchase. In addition, the merchant may automatically trigger image capture device 120 to capture and record the image of the customer at the point of purchase.

It is important to note that the captured image of the customer is another example of a recorded communication in association with a transaction because the image communicates the consumer's presence at the point of purchase. Merchant system 902 transfers the captured image, such as “image YZ” illustrated at reference numeral 914, to transaction controller 148. Transaction controller 148 stores the image recording in transaction database 150 in association with the transaction agreed to at merchant system 902, as illustrated at reference numeral 924.

It will be understood that a provider may offer one or more recording options for a customer and that the customer may select each option or the provider may automatically perform each option. In addition, it will be understood that capture of a still or video image of a customer may also occur during a telephone based transaction, particularly where the telephone call is a video conference call or a telephone call through a provider that enables opening multiple channels during the telephone call to facilitate different types of recordable communications. Further, it will be understood that a customer may also select to record text at interface system 908 and merchant system 902 records text entries by the customer and records the text entries as an additional communication associated with the transaction in transaction database 150.

Referring now to FIG. 10, a high level logic flowchart depicts a process and program for managing recordings of communications in association with a transaction for a customer. In the example, the process starts at block 1000 and thereafter proceeds to block 1002. Block 1002 depicts a determination whether a selection to record a communication in association with a transaction is detected. In one example, a customer is offered the option to record a communication and authorizes recording of the communication. In another example, a customer's profile includes an automatic authorization for recording a communication. In yet another example, the provider automatically selects to record particular types of communications. Further, in yet another example, a live attendant representing the provide selects to record a communication in association with a transaction between a customer and the provider.

At block 1002, if a selection to record is detected, then the process passes to block 1004. Block 1004 depicts the provider recording the communication with the customer. Next, block 1006 illustrates the provider associating the recorded communication with a transaction associated with the communication. Thereafter, block 1012 depicts the provider determining whether the customer requests a real-time streaming of the recording of the communication. If the customer requests the real-time streaming, then the process passes to block 1014. Block 1014 depicts streaming the requested communication in the requested format to the customer communication device, and the process passes to block 1016. Returning to block 1012, if the customer does not request the real-time streaming, then the process passes to block 1016. Block 1016 depicts a determination whether the recording is complete. Once the recording is complete, then the process passes to block 1008.

Block 1008 depicts the provider storing the recorded communication in a database associated with an identifier for the transaction and an identifier for the customer. Next, block 1010 illustrates the provider facilitating an interface for the customer to access the recorded communication from the database, and the process ends.

With reference now to FIG. 11, a high level logic flowchart depicts a process and program for managing customer accesses to previously recorded communications in association with a transaction between the customer and the provider. In the example, the process starts at block 1100 and thereafter proceeds to block 1102. Block 1102 depicts a determination whether the customer requests access to a previously recorded communication in association with a transaction. If the customer requests access to a previously recorded communication, then the process passes to block 1104. Block 1104 illustrates accessing the transactions and recorded communications associated with the customer or a specific transaction or recorded communication requested by the customer. Next, block 1106 depicts presenting the accessed recorded communication to the customer for customer selection of a particular recorded communication from among the accessed recordings. Thereafter, block 1108 illustrates a determination as to what type of input is detected from the customer.

In one example, at block 1108, if the customer requests to listen to a particular recorded communication, then the process passes to block 1114. Block 1114 depicts controlling output of the recorded communication with play options, and the process returns to block 1108.

In another example, at block 1108, if the customer requests to bookmark the recorded communication, then the process passes to block 1112. Block 1112 illustrates adding the selected time signature of the recorded communication when the bookmarking selection is made to the recording entry in the transaction database, and the process returns to block 1108.

In another example, at block 1108, if the customer requests to contest the recorded communication or the transaction associated with the recorded communication, then the process passes to block 1110. Block 1110 depicts marking the record of the transaction associated with the recorded communication or the recorded communication itself as contested in the transaction database, and the process returns to block 1108.

In addition, at block 1108, the customer may select other options that would terminate the current communication through the output interface, such as hanging up, logging out, or not responding for a particular period of time. If the customer selects an option to terminate the current communication, then the process ends.

While the invention has been particularly shown and described with reference to a preferred embodiment, it will be understood by those skilled in the art that various changes in form and detail may be made therein without departing from the spirit and scope of the invention

What is claimed is:

1. A method for managing, by a provider, access by a customer to a recording of a communication between a customer and said provider, comprising:
detecting a selection to record a communication between a customer and a provider in association with a particular transaction between said customer and said provider;
recording, by said provider, said communication between said customer and said provider;
storing said recorded communication in a database in association with said particular transaction; and
facilitating an interface for said customer to access said recorded communication from said database.

2. The method according to claim 1, wherein detecting a selection to record a communication between a customer and a provider in association with a particular transaction between said customer and said provider, further comprises:
prompting said customer during a telephone call to select to record said communication between said customer and said provider in association with a transaction between said customer and said provider; and
responsive to said customer selection to record said communication, triggering recording of said communication during said telephone call between said customer and said provider.

3. The method according to claim 1, wherein detecting a selection to record a communication between a customer and a provider in association with a particular transaction between said customer and said provider, further comprises:
detecting a selection to record an image of said customer; and
capturing an image of said customer at a point of purchase for facilitating said transaction.

4. The method according to claim 1, wherein storing said communication in a database in association with said particular transaction, further comprises:
converting said recording from a voice communication format to a second recording in a text format; and
storing said recording in said voice communication format and second recording in said database in association with said transaction.

5. The method according to claim 1, wherein facilitating an interface for said customer to access said recorded communication from said database, further comprises:
generating an electronic mail addressed to said customer comprising at least one of a link to access said recorded communication from said database and an attached copy of said recorded communication from said database; and
sending said electronic mail to said customer.

6. The method according to claim 1, wherein facilitating an interface for said customer to access said recorded communication from said database, further comprises:
receiving a request from said customer via a web site interface to access a transaction history for said customer;
searching said database for at least one transaction associated with said customer; and
generating a web page for said customer displaying said at least one transaction and at least one recorded communication previously stored in said database in association with said transaction, wherein said display of said recorded communication is selectable for access to said recorded communication by said customer.

7. The method according to claim 1, wherein facilitating an interface for said customer to access said recorded communication from said database, further comprises:
providing said customer, during a telephone call, with a menu of selectable options, wherein at least one option from said menu enables said customer to select to access said recorded communication;
responsive to detecting a selection by said customer to access said recorded communication, accessing said recorded communication from said database; and
controlling output of said recorded communication to said customer via at least one communication channel enabled during said telephone call between said customer and said provider.

8. The method according to claim 1, wherein facilitating an interface for said customer to access said recorded communication from said database, further comprises:
facilitating an audio player for said customer to listen to said recorded communication, wherein said recorded communication comprises a voice recording; and
enabling said audio player with a selectable option to bookmark a time signature during play of said recorded communication;
responsive to a selection by said customer of said selectable option to bookmark during play of said recorded communication, marking a particular time signature during said recorded communication; and
updating said database with said particular time signature in association with said recorded communication.

9. The method according to claim 1, wherein said recorded communication comprises at least one from among a voice recording, a captured still image of said customer, a captured video clip of said customer, and a text communication.

10. The method according to claim 1, wherein said particular transaction is a financial transaction and wherein said provider is a financial institution.

11. The method according to claim 1, further comprising:
streaming, by said provider, said recorded communication in real-time to said customer as said communication is occurring;

12. A system for managing access by a customer to a recording of a communication between a customer and a provider, comprising:
a communication system for enabling said customer to communicate with said provider;
said communication system further comprising:
means for detecting a selection to record a communication between a customer and a provider in association with a particular transaction between said customer and said provider;
means for recording said communication between said customer and said provider;
means for storing said recorded communication in a database in association with said particular transaction; and
means for facilitating an interface for said customer to access said recorded communication from said database.

13. The system according to claim 12, wherein said means for detecting a selection to record a communication between a customer and a provider in association with a particular transaction between said customer and said provider, further comprises:
means for prompting said customer during a telephone call to select to record said communication between said customer and said provider in association with said particular transaction between said customer and said provider; and
responsive to said customer selection to record said communication, triggering recording of said communication during said telephone call between said customer and said provider.

14. The system according to claim 12, said means for detecting a selection to record a communication between a customer and a provider in association with a particular transaction between said customer and said provider, further comprises:
means for detecting a selection to record an image of said customer; and
means for capturing an image of said customer at a point of purchase for facilitating said transaction.

15. The system according to claim 12, said means for storing said communication in a database in association with said particular transaction, further comprises:
means for converting said recording from a voice communication format to a second recording in a text format; and
means for storing said recording in said voice communication format and second recording in said database in association with said transaction.

16. The system according to claim 12, said means for facilitating an interface for said customer to access said recorded communication from said database, further comprises:
means for generating an electronic mail addressed to said customer comprising at least one of a link to access said recorded communication from said database and an attached copy of said recorded communication from said database; and
means for sending said electronic mail to said customer.

17. The system according to claim 12, said means for facilitating an interface for said customer to access said recorded communication from said database, further comprises:
means for receiving a request from said customer via a web site interface to access a transaction history for said customer;
means for searching said database for at least one transaction associated with said customer; and
means for generating a web page for said customer displaying said at least one transaction and at least one recorded communication previously stored in said database in association with said transaction, wherein said display of said recorded communication is selectable for access to said recorded communication by said customer.

18. The system according to claim 12, said means for facilitating an interface for said customer to access said recorded communication from said database, further comprises:
means for providing said customer, during a telephone call, with a menu of selectable options, wherein at least one option from said menu enables said customer to select to access said recorded communication;
means, responsive to detecting a selection by said customer to access said recorded communication, for accessing said recorded communication from said database; and
means for controlling output of said recorded communication to said customer via at least one communication channel enabled during said telephone call between said customer and said provider.

19. The system according to claim 12, said means for facilitating an interface for said customer to access said recorded communication from said database, further comprises:
means for facilitating an audio player for said customer to listen to said recorded communication, wherein said recorded communication comprises a voice recording; and
means for enabling said audio player with a selectable option to bookmark a time signature during play of said recorded communication;
means, responsive to a selection by said customer of said selectable option to bookmark during play of said recorded communication, for marking a particular time signature during said recorded communication; and
means for updating said database with said particular time signature in association with said recorded communication.

20. A program for managing access by a customer to a recording of a communication made by a provider between said customer and said provider, said program embodied in a computer-readable medium, said program comprising computer-executable instructions which cause a computer to perform the steps of:
detecting a selection to record a communication between said customer and said provider in association with a particular transaction between said customer and said provider;
recording, by said provider, said communication between said customer and said provider;
storing said recorded communication in a database in association with said particular transaction; and
facilitating an interface for said customer to access said recorded communication from said database.
